(19) United States
(12) Patent Application Publication
(10) Pub. No.: US 2014/0254678 A1
(43) Pub. Date: Sep. 11, 2014

(54) MOTION ESTIMATION USING HIERARCHICAL PHASE PLANE CORRELATION AND BLOCK MATCHING

(71) Applicants: Aleksandar Beric, Eindhovenn (NL); Zdravko Pantic, Beograd (RS); Vladimir Kovacevic, Belgrade (RS); Radomir Jakovljevic, Belgrade (RS); Milos Markovic, Belgrade (RS)

(72) Inventors: Aleksandar Beric, Eindhovenn (NL); Zdravko Pantic, Beograd (RS); Vladimir Kovacevic, Belgrade (RS); Radomir Jakovljevic, Belgrade (RS); Milos Markovic, Belgrade (RS)

(21) Appl. No.: 13/793,029

(22) Filed: Mar. 11, 2013

(51) Int. Cl. H04N 7/26

(52) U.S. Cl. CPC H04N 19/00684
USPC 375/240.14

(57) ABSTRACT

Systems, apparatus, articles, and methods are described related to motion estimation using hierarchical phase plane correlation and block matching.

### BACKGROUND

A video encoder compresses video information so that more information can be sent over a given bandwidth. The compressed signal may then be transmitted to a receiver that decodes or decompresses the signal prior to display. To compress the video information, a video encoder may include a motion estimator, which may generate motion vectors that describe the transformation from one frame of video to another (e.g., adjacent or consecutive frames). Sending motion vectors, or information related to the motion vectors (after further processing, for example) may conserve substantial bandwidth.

Some widely used motion estimation algorithms include block matching algorithms, which may be less complex than other approaches. Such block matching algorithms are typically used in very large scale integration (VLSI) implementations and are often present in video compression codecs such as, for example, the H.261 International Telecommunication Union (ITU) Telecommunication Standardization Sector (ITU-T) video coding standard and the Moving Picture Experts Group (MPEG) phase 1 (MPEG-1) standard and the MPEG-2 standard. Block matching estimation typically includes, for an individual block of a frame k, searching for a “best match” block in frame k+1, where frame k and frame k+1 may be adjacent or consecutive frames in a video, for example, and a vector describing the displacement between the individual block in frame k and the best match block in frame k+1 is the motion vector for the individual block. Any number of motion vectors (for any number of blocks) may provide the transformation for the frames and the motion vectors may be combined to form a motion vector field.

In some block matching implementations, the candidate blocks in frame k+1 may be used for determining the best match include blocks within a search region of frame k+1 around the location corresponding to the location of the individual block in frame k (i.e., frame k+1 is searched in an area around the location where the individual block would be if it did not move between frame k and frame k+1). Techniques that search every possible block are called full search block matching and offer the advantages of being straightforward and providing a complete search. But, full search block matching techniques have limitations such as high computational complexity, not capturing real motion in a scene, not being able to deal with occluded areas, and not handling repetitive structures, for example.

Other motion estimation techniques include efficient search strategies, which may reduce the candidate regions for block matching. Such techniques include iterative algorithms (e.g., three step searching algorithms), logarithmic searching, or one-at-a-time search (OTS), for example. Each of these techniques attempt to find best match blocks (and associated motion vector) on a coarse pixel grid. The next step in the iterative process is to find a new best match block (and associated motion vector) on a finer pixel grid centralized around the pixel of the previous best match. Such iterations may be repeated to improve accuracy at the cost of computing resources and/or time. These techniques, as compared to the full search block matcher, may offer the advantage of less computations but they may not meet the quality of a full search. Further, such techniques may find local block matches but may miss global matches.

Another technique for motion estimation is the phase plane correlation algorithm, which attempts to measure the direction of speed of a moving object rather than searching for motion, for example. In phase plane correlation algorithms, for two frames (i.e., frames k and k+1), a windowing function is applied to the frames to reduce edge effects and a Fourier transform is applied. A cross power spectrum is then determined between by multiplying element-wise spectrum of frame k and the complex conjugate of spectrum of frame k+1 and normalizing the product. An inverse Fourier transform is applied to the cross power spectrum and an optional fast Fourier transform shift may be applied, and in either event a correlation plane is generated. The correlation plane is then searched for peaks such that indices of peaks represent displacement between the frames, and the displacement may be described as a motion vector.

A single stage phase plane correlation may not be capable of providing motion vectors for multiple objects in a scene. To solve this problem, hierarchical phase plane correlation may be applied such that several levels of phase plane correlation may be applied to produce an accurate and robust motion vector field. In comparison to the other described techniques, a major drawback of hierarchical phase plane correlation techniques is complexity.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example video coding system;

FIG. 2 is an illustrative diagram of dividing and/or downscaling image data of a video frame;

FIG. 3 is an illustrative diagram of an individual block within image data of a video frame;

FIG. 4 is an illustrative diagram of block matching between image data of video frames;

FIG. 5 is a flow chart illustrating an example video coding process;

FIG. 6 is an illustrative diagram of an example video coding process in operation;

FIG. 7 is an illustrative diagram of an example video coding system;

FIG. 8 is an illustrative diagram of an example system; and

FIG. 9 is an illustrative diagram of an example system, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, “embodiment”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, aspect, element, or characteristic is described in connection with an implementation or embodiment, it is submitted that it is within the knowledge of one skilled in the art to effect such feature, structure, aspect, element, or characteristic in connection with other implementations or embodiments whether or not explicitly described herein. Any feature, structure, aspect, element, or characteristic from an embodiment can be combined with any feature, structure, aspect, element, or characteristic of any other embodiment.

Systems, apparatus, articles, and methods are described below related to motion estimation using hierarchical phase plane correlation and block matching.

As described above, in video coding systems, a video encoder may compress video information for transmission. To compress the video information, a video encoder may include a motion estimator, which may generate motion vectors (e.g., a motion vector field) that may describe transformation from one frame of video to another. Further, current techniques may suffer from various deficiencies such as inaccuracy, local or global bias, being computationally intensive, or the like.

As will be described in greater detail below, a video encoder may generate motion vectors by applying, to image data of two video frames (e.g., consecutive video frames) a hierarchical phase plane correlation. The hierarchical phase plane correlation may have a limited number of hierarchical levels, such as, for example, two levels (e.g., a local level and a global level). The hierarchical phase plane correlation may generate candidate motion vectors. In general, a motion vector may describe a translation such that, for an individual block in a first frame (i.e., frame k), a motion vector may define or be associated with a block in a second frame (i.e., frame k+1) displaced from where the individual block would be in the second frame (e.g., if the individual frame did not move) by the motion vector. Therefore, a candidate motion vector may be associated with a candidate block, and the like. The candidate motion vectors associated with an individual block may then be evaluated by performing a block matching based on the candidate blocks defined by the candidate motion vectors determined by the hierarchical phase plane correlation. Based on a best match of the candidate blocks, a motion vector for the individual block may be chosen. Such an implementation may be repeated or performed in parallel (or partially in parallel) for any or all of the individual blocks of the image data of the frame and the best match motion vectors for the evaluated blocks may define a motion vector field describing a transformation from the first frame to the second frame.

Further, the described block matching may evaluate a variety of candidate blocks (which are associated, as discussed, with candidate motion vectors). Additional candidate motion vectors may be provided based on the hierarchical phase plane correlation, which may provide multiple candidate motion vectors for an individual block. For example, the hierarchical phase plane correlation may provide one or more local candidate motion vectors and/or one or more global candidate motion vectors for the individual block. Further, the block matching may evaluate candidate blocks associated with candidate vectors not produced by the hierarchical phase plane correlation, such as, for example, candidate vectors associated with best match vectors from previous motion estimation iterations, candidate vectors associated with best match vectors from previous motion estimation iterations adjusted by a modification vectors, or candidate vectors associated with best match vectors for blocks that are neighbors of the individual block. The use of such additional candidate vectors may be advantageous since motion in a video may be of a constant velocity and/or neighboring blocks (e.g., representing an object in motion) may move together. The techniques discussed herein may offer the advantage of limiting the number of hierarchical levels in the phase plane correlation along with limiting the number of candidate blocks in the block matching to thereby reduce computational complexity while producing high quality video for a given bandwidth.

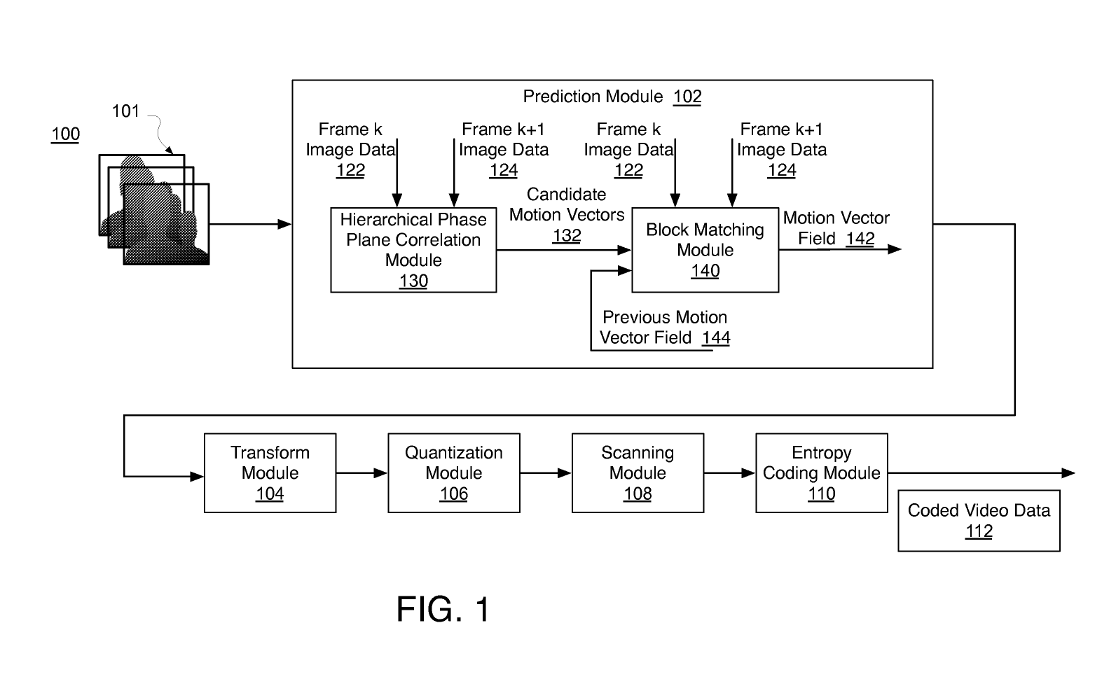

FIG. 1 is an illustrative diagram of an example video coding system 100, arranged in accordance with at least some implementations of the present disclosure. In various implementations, video coding system 100 may be configured to undertake video coding and/or implement video codecs according to one or more advanced video codec standards, such as, for example, the High Efficiency Video Coding (HEVC) H.265 video compression standard being developed by the Joint Collaborative Team on Video Coding (JCT-VC) formed by ISO/IEC Moving Picture Experts Group (MPEG) and ITU-T Video Coding Experts Group (VCEG). Further, in various embodiments, video coding system 100 may be implemented as part of an image processor, video processor, and/or media processor and may undertake inter prediction, intra prediction, predictive coding, and/or residual prediction.

As used herein, the term “coder” may refer to an encoder and/or a decoder. Similarly, as used herein, the term “coding” may refer to encoding via an encoder and/or decoding via a decoder. For example video encoder 103 and video decoder 105 may both be examples of coders capable of coding.

In some examples, video coding system 100 may include additional items that have not been shown in FIG. 1 for the sake of clarity. For example, video coding system 100 may include a processor, a radio frequency-type (RF) transceiver, a display, and/or an antenna. Further, video coding system 100 may include additional items such as a speaker, a microphone, an accelerometer, memory, a router, network interface logic, etc. that have not been shown in FIG. 1 for the sake of clarity.

As shown, video coding system 100 may include a prediction module 102, a transform module 104, a quantization module 106, a scanning module 108, and an entropy encoding module 110. In various implementations, video coding system 100 may be configured to encode video data (e.g., in the form of video frames or pictures) according to various video coding standards and/or specifications. For example, video coding system 100 may receive input video data 101 and transmit or provide coded video data. As shown, prediction module 102 may implement hierarchical phase plane correlation module 130 and block matching module 140, which may provide hierarchical phase plane correlation to generate candidate motion vectors and block matching on those candidates and, optionally, additional candidates to determine, for an individual block of a first video frame, a matching block and a motion vector associated with the matching block and a motion vector field 142 having motion vectors for multiple individual blocks of the first video frame, as is discussed further below. In some implementations, hierarchical phase plane correlation module 130 and block matching module 140 may be implemented via a motion estimator or a real velocity estimator, for example. For example, output from hierarchical phase plane correlation module 130 may reflect real motion in a scene and although it may not provide enough accuracy alone, it may provide good initial candidate motion vectors for use by block matching module 140.

In addition to the described motion estimation, prediction module 102 may perform spatial and/or other temporal prediction using input video data 101. For example, input video image frames may be decomposed into slices that are further sub-divided into macroblocks for the purposes of encoding. Prediction module 102 may apply known spatial (intra) prediction techniques and/or known temporal (inter) prediction techniques to predict macroblock data values.

As shown, transform module 104 may then apply known transform techniques to the macroblocks to spatially decorrelate the macroblock data. Those of skill in the art may recognize that transform module 104 may first sub-divide 16×16 macroblocks into 4×4 or 8×8 blocks before applying appropriately sized transform matrices, for example.

Quantization module 106 may then quantize the transform coefficients in response to a quantization control parameter that may be changed, for example, on a per-macroblock basis. For example, for 8-bit sample depth the quantization control parameter may have 52 possible values. In addition, the quantization step size may not be linearly related to the quantization control parameter.

Scanning module 108 may then scan the matrices of quantized transform coefficients using various known scan order schemes to generate a string of transform coefficient symbol elements. The transform coefficient symbol elements as well as additional syntax elements such as macroblock type, intra prediction modes, motion vectors, reference picture indexes, residual transform coefficients, and so forth may then be provided to entropy coding module 110, which may in turn output coded video data 112.

Returning now to prediction module 102, as shown, prediction module 102 may receive input video data 101. Input video data 101 may include any suitable input data including, for example, consecutive frames in a video including a first frame, frame k, and a second frame, frame k+1. The techniques will generally be described in relation to consecutive frames k and k+1. Further, the techniques may typically be performed on raw video frames. In some examples the techniques may be performed at a video decoder such that the described techniques may be performed after a video stream (e.g., a video bit stream) is decoded. In various examples, the techniques may be used between any two frames of any types such as, for example, I-frames, P-frames, or B-frames, or the like.

As shown, hierarchical phase plane correlation module 130 and block matching module 140 may receive frame k image data 122 and frame k+1 image data 124. The image data may be any suitable image data associated with the frames, such as, for example, luminance data of the frames. In other examples, the image data may be chrominance data or a combination of chrominance data and luminance data. In general, using only luminance data may provide the advantage of limiting calculations while providing adequate information to generate motion vector field 142.

As discussed, hierarchical phase plane correlation module 130 may receive frame k image data 122 and frame k+1 image data 124. Frame k image data 122 and frame k+1 image data 124 may be received at prediction module 102 or generated within prediction module 102 from input video data 101. Hierarchical phase plane correlation module 130 may perform a phase plane correlation on frame k image data 122 and frame k+1 image data 122 to generate candidate motion vectors 132. Candidate motion vectors 132 may include, for individual blocks of frame k image data 122, one or more candidate motion vectors for evaluation by block matching module 140, as is discussed further below.

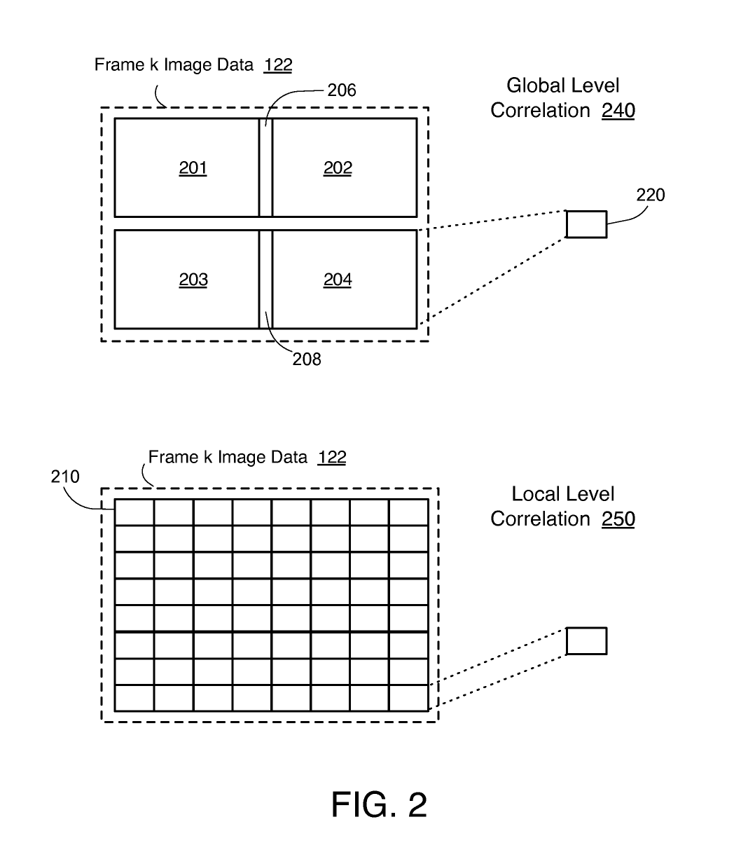

In general, the hierarchical phase plane correlation implemented via hierarchical phase plane correlation module 130 may include any number of hierarchical levels such as, for example, two levels. It may be advantageous to limit the hierarchical levels save on computation power while still providing quality candidate motion vectors 132, for example. An example of dividing image data of frames for a hierarchical phase plane correlation using two levels, a local level and a global level, is shown in FIG. 2.

FIG. 2 is an illustrative diagram of dividing and/or downscaling image data of a video frame, arranged in accordance with at least some implementations of the present disclosure. As shown, frame k image data 122 may be divided, for a global level correlation 240, into regions 201-204 and, for local level correlation 250, into regions 210. Regions 201-204 may be termed global regions and regions 210 may be termed local regions, for example. As shown, in some examples, regions 201-204 may overlap at overlapping areas 206 and 208. In other examples, no overlap may be used. Further, overlapping areas 206 and 208 illustrate example horizontal overlaps and, in some examples, a vertical overlap (not shown for clarity) may be used in addition to or as an alternative to the illustrated horizontal overlaps. Similarly, regions 210 may overlap in the horizontal, the vertical, or both, although no overlap is shown for the sake of clarity.

As discussed, frame k image data 122 may be divided into regions 201-204 for a global phase plane correlation. In general, any number of regions may be used for global level correlation 240 such as four regions as shown. Also as discussed, frame k image data 122 may be divided into regions 210 for a local phase plane correlation. In general, any number of regions may be used for local level correlation 250 such as, for example, 64 regions as shown.

Further, frame k image data 122 may be any resolution and any aspect ratio such as, for example, 1920×1080, 2048×1024, 2560×2048, or the like. As will be appreciated, FIG. 2 illustrates the described dividing operations with respect to frame k image data 122. In the discussed techniques, both frame k image data 122 and frame k+1 image data 124 may be divided and processed such that any regions of frame k image data 122 have corresponding regions of frame k+1 image data 124. However, the dividing of frame k+1 image data 124 is not shown in FIG. 2 for the sake of brevity.

As will be discussed below, for individual regions of regions 201-204 and regions 210, a phase plane correlation may be performed (e.g., a global phase plane correlation for regions 201-204 and a local phase plane correlation for regions 210). The phase plane correlations may be performed between a region of regions 201-204 or regions 210 of frame k image data 122 and an associated region of frame k+1 image data 122. Optionally, prior to performing the phase plane correlation, some or all of regions 201-204 and/or regions 210 may be downscaled. For example, regions 201-204 may downscaled to a downscaled region 220, as shown. The downscaling may be performed by any suitable technique such as pixel dropping (thereby disregarding aliasing effects), for example. Downscaled region 220 may have any suitable size such as, for example, a standardized size of 128×64 pixels. In various examples, regions 210 may be selected to be a size that does not require downscaling (as shown) or regions 210 may be similarly downscaled. Downscaled region 220 may be the same size as the resultant region size in the local level or they may be different. In general, the downscaling at the global level and/or the local level may be performed by any downscaling factor. In some examples, the downscaling factor may be a power of two, which may aide in ease of hardware implementation.

As discussed, the phase plane correlation may include a hierarchical phase plane correlation using two levels, which herein are labeled global and local for convenience. The phase plane correlation may include dividing frame k image data 122 and frame k+1 image data 124 into global regions (e.g., four regions as shown in FIG. 2) and, optionally, downscaling the regions to a standard region size. Similarly, the phase plane correlation may include dividing frame k image data 122 and frame k+1 image data 124 into local regions (e.g., regions 210) and, optionally, downscaling the regions to a standard region size.

Returning now to FIG. 1, the hierarchical phase plane correlation may continue with performing a global phase plane correlation and a local phase plane correlation. The global phase plane correlation may include performing global phase plane correlations on the global regions of frame k image data 122 and the corresponding global regions of frame k+1 image data 124. Similarly, the local phase plane correlation may include performing local phase plane correlations on the local regions of frame k image data 122 and the corresponding local regions of frame k+1 image data 124. In general, a phase plane correlation between regions may be performed using the following techniques, which are first described with respect to region 201 (please see FIG. 2) of frame k image data 122.

As discussed, region 201 of frame k image data 122 has a corresponding region of frame k+1 image data 124. In general, regions may be corresponding if they represent the same portion or substantially the same portion of the video frames (e.g., video frames k and k+1). Further, as discussed region 201 of frame k image data 122 and the corresponding region of frame k+1 image data 124 may be downscaled by a downscaling factor, as discussed.

A windowing function may be applied to region 201 of frame k image data 122 and the corresponding region of frame k+1 image data 124 (or the downscaled regions). The windowing function may include, for example, a Hamming or Kaiser windowing function and may reduce edge effects in the regions.

A discrete Fourier transform may then be applied to region 201 of frame k image data 122 and the corresponding region of frame k+1 image data 124. The discrete Fourier transform may be implemented using a radix-2 Fast Fourier Transform, for example. In some examples the discrete Fourier transform operation may be implemented as shown in equations (1) and (2):

Gₐ=DFT{gₐ} (1)

G_{b}=DFT{g_{b}} (2)

where gₐ may be region 201 of frame k image data 122 (or downscaled and windowed region 201, as discussed), g_{b} may be the corresponding region of frame k+1 image data 124 (or downscaled and windowed corresponding region, as discussed), DFT may represent a discrete Fourier transform, Gₐ may be a transformed region 201 of frame k image data 122, and Gₐ may be a transformed corresponding region of frame k+1 image data 124.

A cross power spectrum between the transformed region 201 of frame k image data 122 and the corresponding region 201 of frame k image data 122 may be determined. The cross power spectrum may be determined by multiplying element-wise spectrum of transformed region 201 of frame k image data 122 and the complex conjugate of the transformed corresponding region of frame k+1 image data 124, and normalizing the product. An example cross power spectrum determination is shown in equation (3):

R=GₐG_{b}*/|GₐG_{b}*| (3)

where R may be the cross power spectrum and G_{b}* may be the complex conjugate of the transformed corresponding region of frame k+1 image data 124.

An inverse discrete Fourier transform may be applied to the cross power spectrum and an optional Fast Fourier Transform shift on the inverse transformed cross power spectrum may be performed to generate a correlation plane. The inverse discrete Fourier transform may be applied as shown in equation (4):

r=DFT⁻¹(R) (4)

where r may be the inverse transformed cross power spectrum and DFT⁻¹ may be a discrete Fourier transform. The optional Fast Fourier Transform shift may include switching elements in first and third and second and fourth quarters of the inverse transformed cross power spectrum. An example Fast Fourier Transform shift is shown in equation (5):

c=fftshift(r) (5)

where c may be a correlation plane and fftshift may be a Fast Fourier Transform shift operation.

A correlation of peaks may be determined in the correlation plane to determine a candidate motion vector associated with region 201 of frame k image data 122 and the corresponding region of frame k+1 image data 124. For example, indices of peaks may represent displacement between region 201 of frame k image data 122 and the corresponding region of frame k+1 image data 124. The correlation of peaks may be determined as shown in equation (5):

Δx,Δy=argmax(x,y)

where Δx,Δy may be the candidate motion vector, argmax may be an operation that returns an operation of the maximum, and x,y may represent possible candidate vector peaks being evaluated.

In general, the described phase plane correlation (i.e., applying a windowing function to two corresponding regions, applying a discrete Fourier transform to the regions, determining a cross power spectrum between regions, applying an inverse discrete Fourier transform to the cross power spectrum, optionally performing a Fast Fourier Transform shift on the inverse transformed cross power spectrum to generate a correlation plane, and/or determining a correlation of peaks in the correlation plane to determine a candidate motion vector) may be performed for any two corresponding regions. With reference to FIG. 2, for example, the phase plane correlation may be performed for regions 201-204 of frame k image data 122 and corresponding regions of frame k+1 image data 124 (either with or without the discussed downscaling). Similarly, the phase plane correlation may be performed for regions 210 of frame k image data 122 and corresponding regions of frame k+1 image data 124 (either with or without the discussed downscaling). In the illustrated example, the described phase plane correlation is implemented at two hierarchical levels, global level correlation 240 and the local level correlation 250. In other examples, more levels may be used, such as three or four levels.

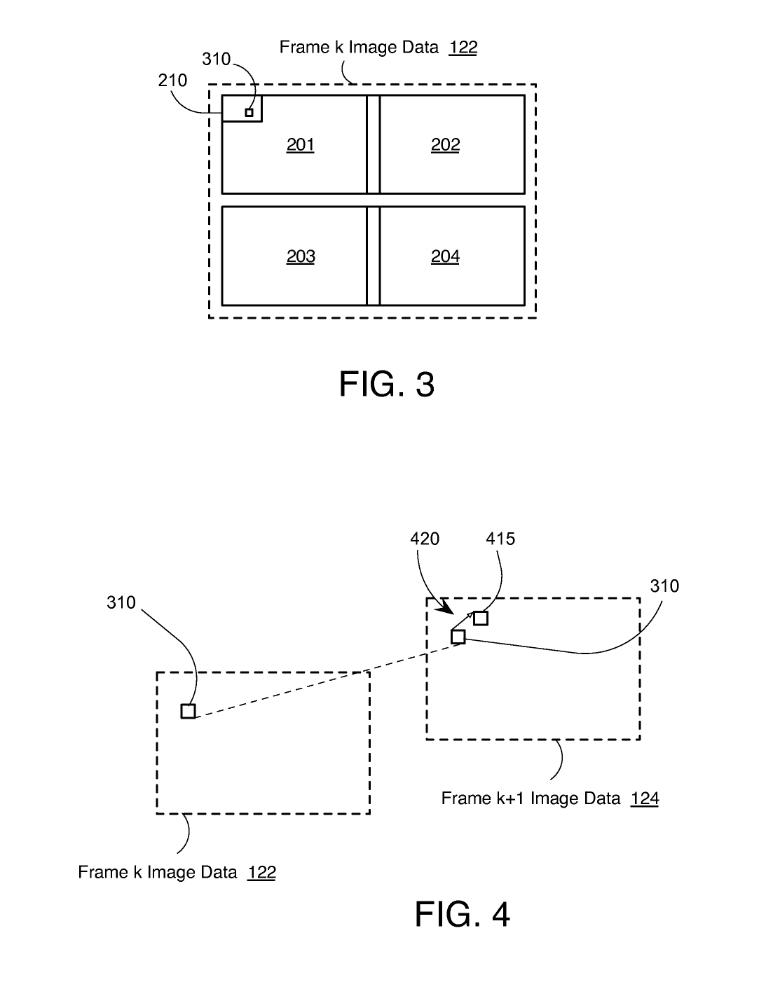

Returning now to FIG. 1, candidate motion vectors 132 may be transferred to block matching module 140. In general, candidate motion vectors 132 may include motion vectors associated with the hierarchical phase plane correlation described above. Block matching module 140 may perform, for an individual block of frame k image data, a block matching based on the individual block and candidate blocks associated with candidate motion vectors 132. For illustrative purposes, reference is made to FIG. 3. FIG. 3 is an illustrative diagram of an individual block 310 within image data of a video frame, arranged in accordance with at least some implementations of the present disclosure. FIG. 3 illustrates regions 201-204 of frame k image data 122, region 210 of frame k image data 122 (a single region 210 is shown for the sake of clarity), and an individual block 310. As will be appreciated, frame k image data 122 may include any number of individual blocks for which motion vectors are to be determined, but a single individual block 310 is shown for the sake of clarity. As shown, individual block 310 may be within global region 201 and individual block 310 may be within local region 210.

As discussed, candidate motion vectors and associated candidate blocks of frame k+1 image data 124 may be evaluated with respect to individual block 310 of frame k image data 122 to determine a matching block of frame k+1 image data 124 and an associated motion vector. As will be appreciated, the matching block may be a “best match” and may not necessarily match the individual block precisely. For illustrative purposes, reference is made to FIG. 4. FIG. 4 is an illustrative diagram of block matching between image data of video frames, arranged in accordance with at least some implementations of the present disclosure. As shown in FIG. 4, individual block 310 of frame k image data 122 may be compared to a candidate block 415 of frame k+1 image data 124. As will be appreciated, in FIG. 4 although individual block 310 is a block of frame k image data 122 (and not frame k+1 image data 124), it is also shown in frame k+1 image data 124 (in the same position as in frame k image data 122) for the purpose of presenting candidate motion vector 420. In general, candidate block 415 may be displaced from individual block 310 by a candidate motion vector 420, as shown. Further, FIG. 4 illustrates that candidate block 415 may be defined or described by candidate motion vector 420. That is, given candidate motion vector 420 (and individual block 310), candidate block 415 may be determined, and subsequently evaluated. For example, referring to FIG. 1, candidate motion vectors 132 may be used to define or determine associated candidate blocks for evaluation by block matching module 140.

In FIG. 4, a single candidate block 415 and associated candidate motion vector 420 are shown. In general, any number of candidate blocks and associated candidate motion vectors may be evaluated to find a best match. For example, turning to FIG. 3, a candidate motion vector associated with region 210 and a candidate motion vector associated with region 201 (as determined by the discussed hierarchal phase plane correlations) may be evaluated for individual block 310 such that the candidate motion vectors of the global and local region for which individual block 310 are within are used as candidate motion vectors and the associated candidate blocks are evaluated. Further, in some examples, an additional candidate block of frame k+1 image data 124 associated with another candidate motion vector determined based on the global phase plane correlation discussed above may be used. For example, the additional candidate motion vector may be a candidate motion vector from a neighboring region (either global or local, as described above) or a second candidate motion vector determined for the region based on the phase plane correlation (either global or local, as described above), or the like.

Further, as shown in FIG. 1, in some implementations, block matching module 140 may receive or retain previous motion vector field 144, which may be a vector field including each or some of the best match (or “winning”) motion vectors from a previous iteration (e.g., an evaluation of a frame k−1 and frame k). In such implementations, a candidate block of frame k+1 image data 124 may be determined based on a previous best match motion vector for individual block 310. For example, in a previous iteration, the described process may have been implemented to determine a best match motion vector for individual block 310. The previous iteration best match motion vector may be used (at the current iteration) to determine an associated candidate block. Such a candidate motion vector and candidate block may offer potential best matches since motion in video tends to include constant velocity motion.

In further implementations, the best match (or “winning”) motion vectors from the previous iteration may also be modified by a modification vector, and the modified vector may be used to determine an associated candidate block. The modification vector may be determined based on a heuristic algorithm or a predetermined modification setting, or the like. Such a candidate motion vector and candidate block may offer potential best matches in instances where the constant velocity assumption needs to be modified by only a small amount, for example. The modified vector may be used in addition to or in place of the previous best match motion vector.

In some implementations, best match vectors from neighbors of individual block 310 may be used as candidate vectors. Such implementations may offer advantages since regions or objects may tend to move together in video. For example, one or more neighboring blocks of individual block 310 may have best match motion vectors (at the current iteration) and one or more of those neighboring best match motion vectors may be used to determine corresponding one or more candidate regions. Typically, individual block 310 may have eight neighboring blocks (above, below, left, right, and four corners). Further, in some examples, a median filter may be applied to three or more neighboring best match motion vectors to determine a candidate motion vector. The median filter may provide a median of the input neighboring best match motion vectors. In an example, the median filter may be provided three neighboring best match motion vectors and the resultant median vector may be a candidate motion vector such that a candidate block may be determined from the candidate motion vector.

As described, a variety of candidate motion vectors may be evaluated by block matching module 140. In general, any combination of any or all of the described candidate motion vectors may be used. In any event, block matching module 140 may perform a block matching on the candidate blocks associated with the implemented candidate motion vectors to determine a matching block. The matching block may be the best match to the individual from the candidate block. For example, performing the block matching may include evaluating a sum of absolute differences between the individual block and the candidate blocks to determine the matching block such that the candidate block with the smallest sum of absolute differences is determined to be the matching block. As shown in FIG. 1, the sum of absolute differences may be determined based on an individual block of frame k image data 122 and candidate blocks of frame k+1 image data 124 at block matching module 140.

In general, the sum of absolute differences may be based on any image data such as, for example, luminance data, chrominance data or a combination of chrominance data and luminance data. An example sum of absolute differences is shown as follows in equation (6):

$$S A {D}_{C , X , n} = {\sum }_{x} \vert {F}_{C , x} - {F}_{X , x} \vert \qquad ( 6 )$$

where SAD may be a sum of absolute differences, C may be a location of the candidate block, X may be a location of the individual block (based on a top left pixel), and x may be a location of a single pixel within the candidate block and the individual block, and F may be image data.

As discussed, based on a best match of the candidate blocks, a motion vector for the individual block may be chosen. Such techniques may be repeated or performed in parallel (or partially in parallel) for any or all of the individual blocks of frame k image data 122 and the best match motion vectors for the evaluated blocks may define motion vector field 142 describing a transformation from frame k image data 122 to frame k+1 image data 124. Further, motion vector field 142 may be modified, combined with other motion estimation information, inter-frame information, intra-frame information, or the like at prediction module 102. The resultant data may be transferred to transform module 104 for further processing, as discussed above, such that coded video data 112 may be provided. As discussed, coded video data 112 may based at least in part on the determined motion vector field 142 and the best match motion vectors therein.

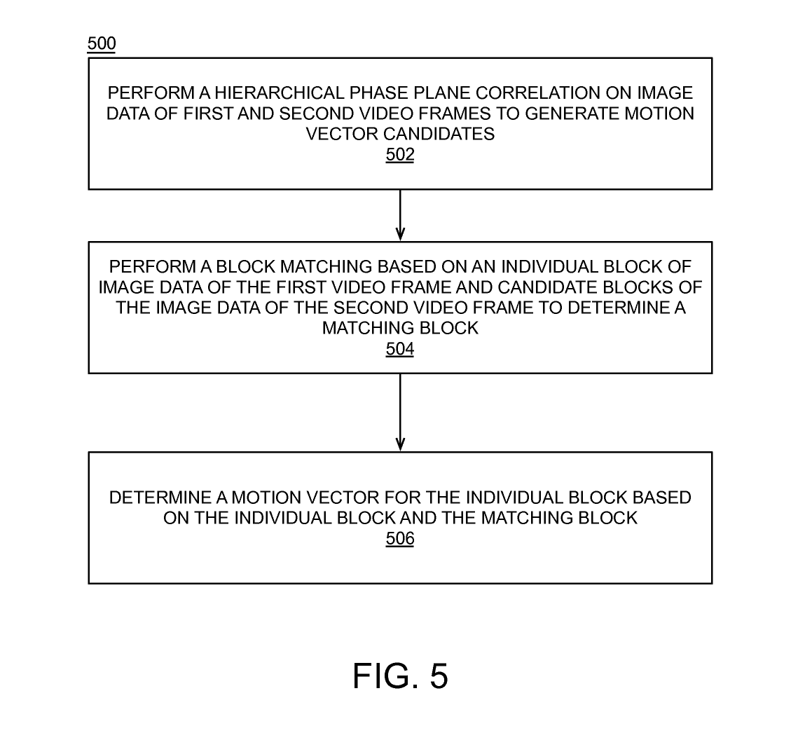

As will be discussed in greater detail below, video coding system 100, as described in FIG. 1 may be used to perform some or all of the various functions discussed below in connection with FIGS. 5 and/or 6.

FIG. 5 is a flow chart illustrating an example video coding process 500, arranged in accordance with at least some implementations of the present disclosure. In the illustrated implementation, process 500 may include one or more operations, functions or actions as illustrated by one or more of blocks 502, 504, and/or 506. By way of non-limiting example, process 500 will be described herein with reference to example video coding system 500 of FIGS. 1 and/or 7. Although process 500, as illustrated, is directed to encoding, the concepts and/or operations described may be applied in the same or similar manner to coding in general, including in decoding.

Process 500 may be utilized as a computer-implemented method for motion estimation. Process 500 may begin at block 502, “PERFORM A HIERARCHICAL PHASE PLANE CORRELATION ON IMAGE DATA OF FIRST AND SECOND VIDEO FRAMES TO GENERATE CANDIDATE MOTION VECTORS”, where a hierarchical phase plane correlation on image data of a first video frame and image data of a second video frame may be performed to generate a plurality of candidate motion vectors. For example, hierarchical phase plane correlation module may perform a global level correlation and a local level correlation on frame k image data 122 and frame k+1 image data 124 to generate candidate motion vectors 132.

Processing may continue from operation 502 to operation 404, “PERFORM A BLOCK MATCHING BASED ON AN INDIVIDUAL BLOCK OF IMAGE DATA OF THE FIRST VIDEO FRAME AND CANDIDATE BLOCKS OF THE IMAGE DATA OF THE SECOND VIDEO FRAME TO DETERMINE A MATCHING BLOCK”, where a block matching may be performed, for an individual block of the image data of first video frame and candidate blocks of the image data of the second video frame to determine a matching block. The candidate blocks may be associated with candidate motion vectors of the candidate motion vectors. For example, a first candidate block may be associated with a first candidate motion vector determined using a phase plane correlation of a global region of frame k+1 image data 124 such that the individual block is within the global region and a second candidate block may be associated with a second candidate motion vector determined using a phase plane correlation of a local region of frame k+1 image data 124 such that the individual block is within the local region.

Processing may continue from operation 504 to operation 506, “DETERMINE A MOTION VECTOR FOR THE INDIVIDUAL BLOCK BASED ON THE INDIVIDUAL BLOCK AND THE MATCHING BLOCK”, where a motion vector for the individual block may be determined based on the individual block and the matching block. For example, the motion vector may include a displacement between the individual block and the matching block.

As discussed, process 500 may be repeated any number of times either serially or in parallel for any number of individual blocks. The resultant motion vectors (associated with matching blocks for each individual block) may be combined to form a motion vector field such as motion vector field 142.

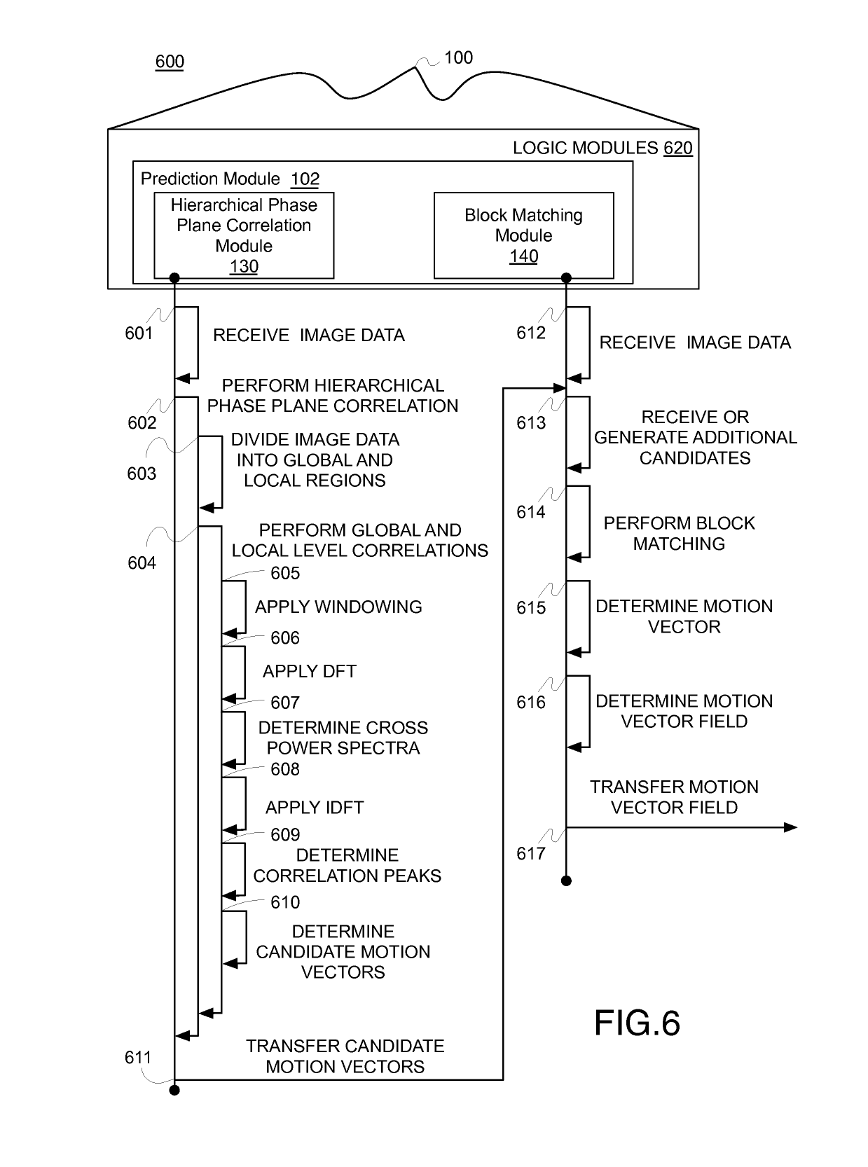

Some additional and/or alternative details related to process 500 may be illustrated in one or more examples of implementations discussed in greater detail below with regard to FIG. 6.

FIG. 6 is an illustrative diagram of example video coding system 100 and video coding process 600 in operation, arranged in accordance with at least some implementations of the present disclosure. In the illustrated implementation, process 600 may include one or more operations, functions or actions as illustrated by one or more of actions 601, 602, 603, 604, 605, 606, 607, 608, 609, 610, 611, 612, 613, 614, 615, 616, and/or 617. By way of non-limiting example, process 600 will be described herein with reference to example video coding system 100 of FIGS. 1 and/or 7.

In the illustrated implementation, video coding system 100 may include logic modules 620, the like, and/or combinations thereof. For example, logic modules 620, may include prediction module 102 which may include hierarchical phase plane correlation module 130 and/or block matching module 140, the like, and/or combinations thereof. Although video coding system 600, as shown in FIG. 6, may include one particular set of blocks or actions associated with particular modules, these blocks or actions may be associated with different modules than the particular module illustrated here. Although process 600, as illustrated, is directed to decoding, the concepts and/or operations described may be applied in the same or similar manner to coding in general, including in encoding.

Process 600 may begin at block 601 and/or block 612, “RECEIVE IMAGE DATA”, where image data for first and second video frames may be received by hierarchical phase plane correlation module 130 and/or block matching module 140. For example, hierarchical phase plane correlation module 130 and/or block matching module 140 may receive frame k image data 122 and frame k+1 image data 124. The modules may receive the image data or simultaneously or in any order such that the modules have the data to perform the described processing.

Processing may continue from operation 601 to operation 602, “PERFORM HIERARCHICAL PHASE PLANE CORRELATION”, where a hierarchical phase plane correlation on image data of a first video frame and image data of a second video frame may be performed to generate a plurality of candidate motion vectors. For example, hierarchical phase plane correlation module may perform a global level correlation and a local level correlation on frame k image data 122 and frame k+1 image data 124 to generate candidate motion vectors 132.

As shown, operation 602 may include sub-operations 603 and 604. At operation 603, “DIVIDE IMAGE DATA INTO GLOBAL AND LOCAL REGIONS”, the image data of the first and second video frames may be divided into global regions and/or local regions. For example, frame k image data 122 may be divided into global regions 201-204 and local regions 210 and frame k+1 image data 124 may be divided into corresponding global regions and corresponding local regions. Although not shown in FIG. 6, the global regions and/or local regions may optionally be downscaled as discussed herein.

Processing may continue form operation 603 to operation 604, “PERFORM GLOBAL AND LOCAL LEVEL CORRELATIONS”, where global phase plane correlations may be performed on the global regions and/or a local phase plane correlations may be performed on the local regions to generate candidate motion vectors. For example, global phase plane correlations may be performed on global regions 201-204 of frame k image data 122 and corresponding global regions of frame k+1 image data 124 and local phase plane correlations may be performed on local regions 210 of frame k image data 122 and corresponding local regions of frame k+1 image data 124.

As shown, operation 604 may include sub-operations 605-610. At operation 605, “APPLY WINDOWING”, a windowing function may be applied to the global regions of the image data of the first video frame and the corresponding global region of the image data of the second video frame and/or a windowing function may be applied to the local regions of the image data of the first video frame and the corresponding local region of the image data of the second video frame. For example, a windowing function may be applied to global regions 201-204 of frame k image data 122 and corresponding global regions of frame k+1 image data 124 and a windowing function may be applied to local regions 210 of frame k image data 122 and corresponding local regions of frame k+1 image data 124.

Processing may continue form operation 605 to operation 606, “APPLY DISCRETE FOURIER TRANSFORM (DFT)”, where a discrete Fourier transform may be applied to the global regions (as modified by the windowing) and/or a discrete Fourier transform may be applied to the local regions (as modified by the windowing). For example, a discrete Fourier transform may be applied to global regions 201-204 of frame k image data 122 and corresponding global regions of frame k+1 image data 124 and a discrete Fourier transform may be applied to local regions 210 of frame k image data 122 and corresponding local regions of frame k+1 image data 124.

Processing may continue form operation 606 to operation 607, “DETERMINE CROSS POWER SPECTRA”, where a cross power spectrum may be determined between each of the global regions of the image data of the first video frame and the corresponding global regions of the image data of the second video frame and/or a cross power spectrum may be determined between each of the local regions of the image data of the first video frame and the corresponding local regions of the image data of the second video frame. For example, a cross power spectrum may be determined for each of global regions 201-204 of frame k image data 122 and corresponding global regions of frame k+1 image data 124 and a cross power spectrum may be determined for each of local regions 210 of frame k image data 122 and corresponding local regions of frame k+1 image data 124.

Processing may continue form operation 607 to operation 608, “APPLY INVERSE DISCRETE FOURIER TRANSFORM (IDFT)”, where a discrete Fourier transform may be applied to each of the cross power spectra. Further, an optional Fast Fourier Transform shift may be performed on the results of the discrete Fourier transform applied to each of the cross power spectra. In either event, correlation planes may be determined. For example, a correlation plane may be generated for each of global regions 201-204 of frame k image data 122 and corresponding global regions of frame k+1 image data 124 and for each of local regions 210 of frame k image data 122 and corresponding local regions of frame k+1 image data 124.

Processing may continue form operation 608 to operation 609, “DETERMINE CORRELATION PEAKS”, where correlation peaks in the correlation planes may be determined. For example, correlation peaks may be determined for each the correlation plane generated for each of global regions 201-204 of frame k image data 122 and corresponding global regions of frame k+1 image data 124 and for each of local regions 210 of frame k image data 122 and corresponding local regions of frame k+1 image data 124.

Processing may continue form operation 609 to operation 610, “DETERMINE CANDIDATE MOTION VECTORS”, where candidate motion vectors may be determined based on the correlation peaks determined using the correlation planes. For example, individual blocks may be within a global region and a local region and the candidate motion vectors may include a local candidate motion vector and a global candidate vector for the individual blocks.

As discussed, operations 605-610 may be considered sub-operations of operation 604 and operations 603 and 604 may be considered sub-operations of operation 602. Processing may therefore continue from operation 602 to operation 611, “TRANSFER CANDIDATE MOTION VECTORS”, where the candidate motion vectors may be transferred from hierarchical phase plane correlation module 130 to block matching module 140.

Processing may continue from operation 611 to optional operation 613, “RECEIVE OR GENERATE ADDITIONAL CANDIDATES”, where additional motion vector candidates may be received or generated. For example, additional motion vector candidates may be generated by block matching module 140 or received form another module of prediction module 102, for example. The additional motion vector candidates may include any discussed herein such as, for example, a candidate motion vector associated with a motion vector selected for an individual region in a previous iteration, a candidate motion vector associated with the motion vector selected for an individual region in a previous iteration modified by a modification vector, or a candidate motion vector associated with neighboring blocks of the individual block, or the like.

Processing may continue from operation 613 to operation 614, “PERFORM BLOCK MATCHING”, where a block matching may be performed, for an individual block of the image data of first video frame and candidate blocks of the image data of the second video frame to determine a matching block. For example, block matching module 140 may perform a block matching for an individual block based on candidate blocks associated with any received or generated candidate motion vectors using a sum of absolute differences technique.

Processing may continue from operation 614 to operation 615, “DETERMINE MOTION VECTOR”, where a motion vector for the individual block may be determined based on the individual block and the matching block. For example, the motion vector may include a displacement between the individual block and the matching block.

Processing may continue from operation 615 to operation 616, “DETERMINE MOTION VECTOR FIELD”, where a motion vector field may be determined. In general, operations 613-615 may be performed for any individual blocks of the image data of first video frame. The determined motion vectors may be combined to form a motion vector field.

Processing may continue from operation 616 to operation 617, “TRANSFER MOTION VECTOR FIELD”, where the motion vector field may be transferred from block matching module 140. For example, block matching module 140 may transfer motion vector field 142 to another module of prediction module 102 for further processing such that data may be transferred from prediction module 102 to transform module 104 and, ultimately, coded video data may be provided.

In operation, processes 500 and 600, as illustrated in FIGS. 5 and 6, may operate so that real velocity estimation for motion estimation may be applied to the problem of video compression, and may be considered as a potential technology to be standardized in the international video codec committees. While implementation of example processes 500 and 600, may include the undertaking of all blocks shown in the order illustrated, the present disclosure is not limited in this regard and, in various examples, implementation of processes 500 and 600 may include the undertaking only a subset of the blocks shown and/or in a different order than illustrated.

In addition, any one or more of the blocks of FIGS. 5 and 6 may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the blocks shown in FIGS. 5 and 6 in response to instructions conveyed to the processor by a computer readable medium.

As used in any implementation described herein, the term “module” refers to any combination of software, firmware and/or hardware configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

The real velocity estimation discussed herein may be used in a wide variety of applications such as, for example, video compression, frame rate up-conversion, digital image stabilization, or the like. In order to compare the techniques described, they were compared to standard techniques using frame rate up-conversion. In those experimental comparisons, the real velocity estimation discussed herein were compared to full search block matching and a commercially available implementation on full high definition (HD) video in a frame rate up-conversion from 30 to 60 frames per second. The computational requirements of the real velocity estimation discussed herein were substantially less than full search block matching (by a factor of about 820 times). Although a comparison of the computational requirements of the real velocity estimation discussed herein and the commercially available implementation was not available, it is expected they will be competitive or less than the commercially available implementation.

Using known frames and comparing the frames determined using rate up-conversion by the real velocity estimation discussed herein, full search block matching, and the commercially available implementation, the determined frames were compared to the known (or reference frames) using peak signal to noise ratio (PSNR) and subjective evaluation. In PSNR, the real velocity estimation discussed herein outperformed full search block matching and the commercially available implementation in 11 out of 12 tested sequences and similar results were found in the subject evaluation.

Given the computational requirements of the real velocity estimation discussed herein and the quality, both objectively and subjectively, of the results, the real velocity estimation discussed herein may provide substantial improvements. Further, the real velocity estimation discussed herein may be highly programmable and suitable to a wide variety of hardware architectures.

Further, as discussed, in some examples, a discrete Fourier transform may be implemented using a radix-2 Fast Fourier Transform. In some implementations the radix-2 Fast Fourier Transform may be optimized with fixed point complex numbers to obtain a large level of instruction and data parallelism. For example, in instances where division is used, complex numbers may be left shifted by a leading number of zeros. The leading number of zeros may be taken from the real part of the complex number if is absolute value is larger than an absolute value of the imaginary part, and vice versa, the number of leading zeros may be taken from the imaginary part of the complex number if is absolute value is larger than an absolute value of the real part.

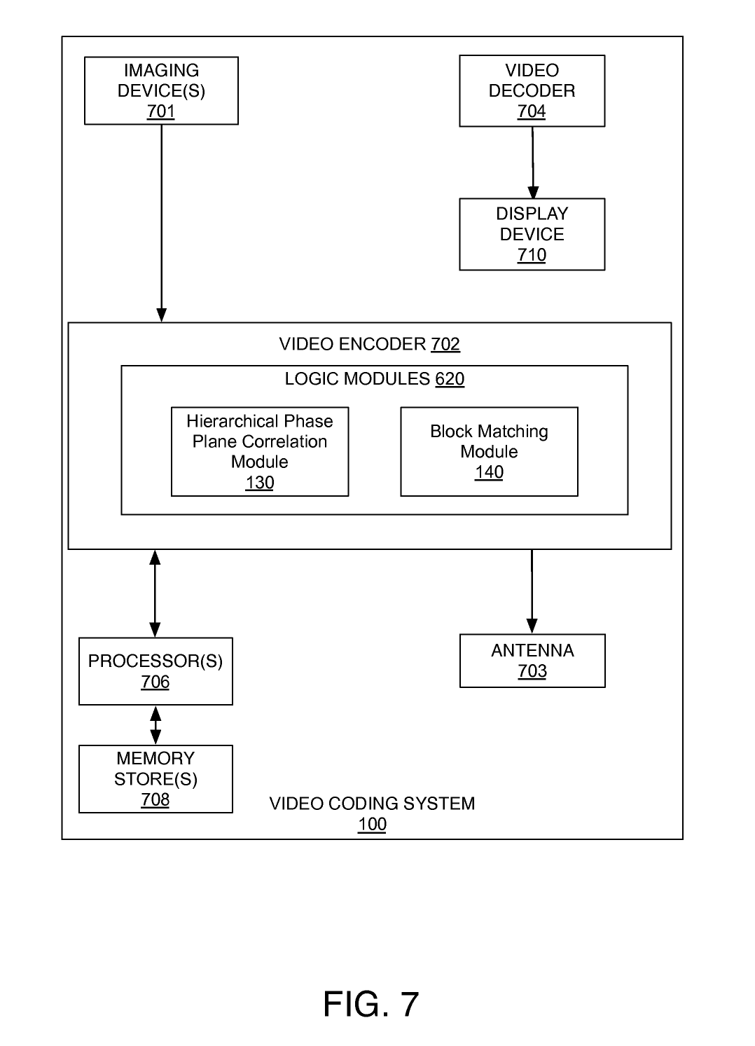

FIG. 7 is an illustrative diagram of an example video coding system 100, arranged in accordance with at least some implementations of the present disclosure. In the illustrated implementation, video coding system 100 may include imaging device(s) 701, a video encoder 702, an antenna 703, a video decoder 704, one or more processors 706, one or more memory stores 708, a display device 710, and/or logic modules 620. Logic modules 620 may include prediction module 102 which may include hierarchical phase plane correlation module 130 and block matching module 140 the like, and/or combinations thereof.

As illustrated, antenna 703, video decoder 704, processor 706, memory store 708, and/or display 710 may be capable of communication with one another and/or communication with portions of logic modules 620. Similarly, imaging device(s) 701 and video encoder 702 may be capable of communication with one another and/or communication with portions of logic modules 620. Accordingly, video encoder 702 may include all or portions of logic modules 620, while video decoder 704 may include similar logic modules. Although video coding system 100, as shown in FIG. 7, may include one particular set of blocks or actions associated with particular modules, these blocks or actions may be associated with different modules than the particular module illustrated here.

In some examples, video coding system 100 may include antenna 703, video decoder 704, the like, and/or combinations thereof. Antenna 703 may be configured to transmit video data. Video encoder 702 may be communicatively coupled to antenna 703 and may be configured to provide video data, such as encoded bitstream data.

In some examples, video coding system 100 may include display device 710, one or more processors 706, one or more memory stores 708, and/or combinations thereof. Display device 710 may be configured to present video data from video decoder 704, for example. Processors 706 may be communicatively coupled to video encoder 702, which may be communicatively coupled to antenna 703. Memory stores 608 may be communicatively coupled to the one or more processors 706. Hierarchical phase plane correlation module 130 and block matching module 140 may be communicatively coupled to the one or more processors 706 (via video encoder 702 in some examples) and may be configured to perform motion estimation using hierarchical phase plane correlation and block matching, as discussed herein.

In some examples, video coding system 100 may include antenna 703, one or more processors 706, one or more memory stores 708, and/or combinations thereof. Processors 706 may be communicatively coupled to video encoder 702, which may be communicatively coupled to antenna 703. Memory stores 608 may be communicatively coupled to the one or more processors 706. Hierarchical phase plane correlation module 130 and block matching module 140 may be communicatively coupled to the one or more processors 706 (via video encoder 702 in some examples) and may be configured to perform motion estimation using hierarchical phase plane correlation and block matching, as discussed herein. Antenna 703 may be configured to transmit video data between video encoder 702 and video decoder 704, such as, for example, transmitting video data based at least in part on the determined motion vector.

In various embodiments, hierarchical phase plane correlation module 130 and/or block matching module 140 may be implemented in hardware, software, firmware or combinations thereof. For example, in some embodiments, hierarchical phase plane correlation module 130 and/or block matching module 140 may be implemented by application-specific integrated circuit (ASIC) logic. In other embodiments, hierarchical phase plane correlation module 130 and/or block matching module 140 may be implemented via a graphics processing unit. In addition, memory stores 708 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory stores 708 may be implemented by cache memory.

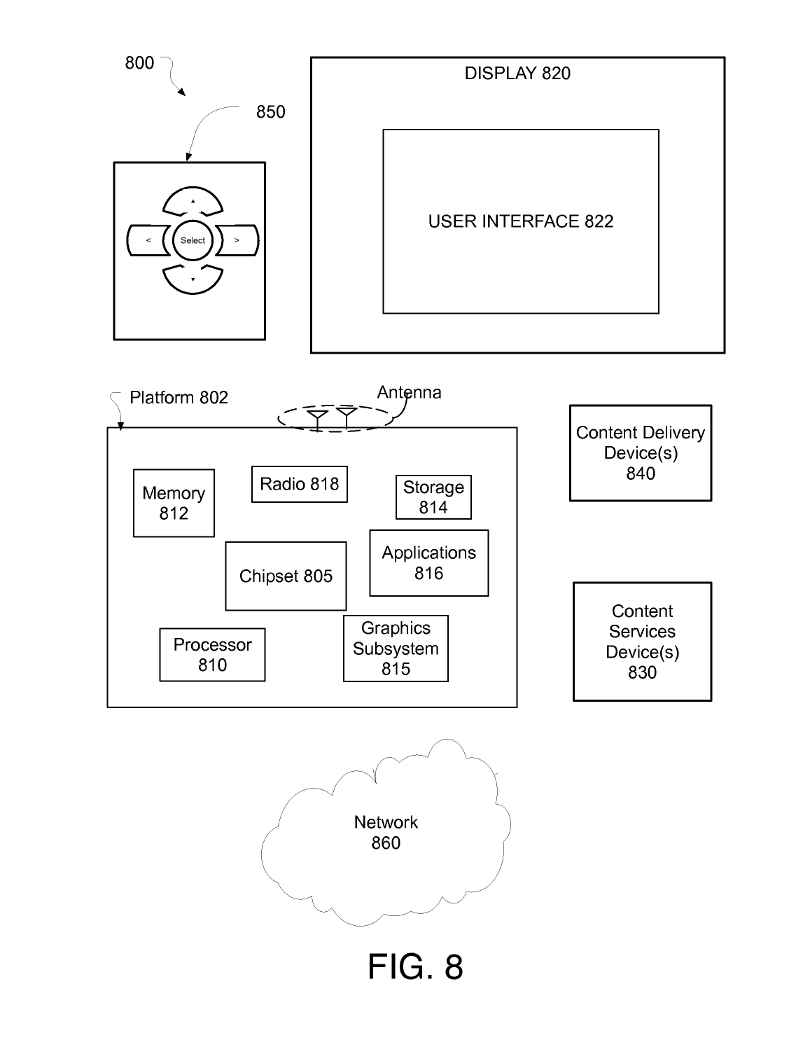

FIG. 8 illustrates an example system 800 in accordance with the present disclosure. In various implementations, system 800 may be a media system although system 800 is not limited to this context. For example, system 800 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 800 includes a platform 802 coupled to a display 820. Platform 802 may receive content from a content device such as content services device(s) 830 or content delivery device(s) 840 or other similar content sources. A navigation controller 850 including one or more navigation features may be used to interact with, for example, platform 802 and/or display 820. Each of these components is described in greater detail below.

In various implementations, platform 802 may include any combination of a chipset 805, processor 810, memory 812, storage 814, graphics subsystem 815, applications 816 and/or radio 818. Chipset 805 may provide intercommunication among processor 810, memory 812, storage 814, graphics subsystem 815, applications 816 and/or radio 818. For example, chipset 805 may include a storage adapter (not depicted) capable of providing intercommunication with storage 814.

Processor 810 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 810 may be dual-core processor(s), dual-core mobile processor(s), and so forth.

Memory 812 may be implemented as a volatile memory device such as, but not limited to, a Random Access Memory (RAM), Dynamic Random Access Memory (DRAM), or Static RAM (SRAM).

Storage 814 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 814 may include technology to increase the storage performance enhanced protection for valuable digital media when multiple hard drives are included, for example.

Graphics subsystem 815 may perform processing of images such as still or video for display. Graphics subsystem 815 may be a graphics processing unit (GPU) or a visual processing unit (VPU), for example. An analog or digital interface may be used to communicatively couple graphics subsystem 815 and display 820. For example, the interface may be any of a High-Definition Multimedia Interface, Display Port, wireless HDMI, and/or wireless HD compliant techniques. Graphics subsystem 815 may be integrated into processor 810 or chipset 805. In some implementations, graphics subsystem 815 may be a stand-alone card communicatively coupled to chipset 805.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 818 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 818 may operate in accordance with one or more applicable standards in any version.

In various implementations, display 820 may include any television type monitor or display. Display 820 may include, for example, a computer display screen, touch screen display, video monitor, television-like device, and/or a television. Display 820 may be digital and/or analog. In various implementations, display 820 may be a holographic display. Also, display 820 may be a transparent surface that may receive a visual projection. Such projections may convey various forms of information, images, and/or objects. For example, such projections may be a visual overlay for a mobile augmented reality (MAR) application. Under the control of one or more software applications 816, platform 802 may display user interface 822 on display 820.

In various implementations, content services device(s) 830 may be hosted by any national, international and/or independent service and thus accessible to platform 802 via the Internet, for example. Content services device(s) 830 may be coupled to platform 802 and/or to display 820. Platform 802 and/or content services device(s) 830 may be coupled to a network 860 to communicate (e.g., send and/or receive) media information to and from network 860. Content delivery device(s) 840 also may be coupled to platform 802 and/or to display 820.

In various implementations, content services device(s) 830 may include a cable television box, personal computer, network, telephone, Internet enabled devices or appliance capable of delivering digital information and/or content, and any other similar device capable of unidirectionally or bidirectionally communicating content between content providers and platform 802 and/display 820, via network 860 or directly. It will be appreciated that the content may be communicated unidirectionally and/or bidirectionally to and from any one of the components in system 800 and a content provider via network 860. Examples of content may include any media information including, for example, video, music, medical and gaming information, and so forth.

Content services device(s) 830 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 802 may receive control signals from navigation controller 850 having one or more navigation features. The navigation features of controller 850 may be used to interact with user interface 822, for example. In embodiments, navigation controller 850 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 850 may be replicated on a display (e.g., display 820) by movements of a pointer, cursor, focus ring, or other visual indicators displayed on the display. For example, under the control of software applications 816, the navigation features located on navigation controller 850 may be mapped to virtual navigation features displayed on user interface 822, for example. In embodiments, controller 850 may not be a separate component but may be integrated into platform 802 and/or display 820. The present disclosure, however, is not limited to the elements or in the context shown or described herein.

In various implementations, drivers (not shown) may include technology to enable users to instantly turn on and off platform 802 like a television with the touch of a button after initial boot-up, when enabled, for example. Program logic may allow platform 802 to stream content to media adaptors or other content services device(s) 830 or content delivery device(s) 840 even when the platform is turned “off.” In addition, chipset 805 may include hardware and/or software support for (7.1) surround sound audio and/or high definition (7.1) surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 800 may be integrated. For example, platform 802 and content services device(s) 830 may be integrated, or platform 802 and content delivery device(s) 840 may be integrated, or platform 802, content services device(s) 830, and content delivery device(s) 840 may be integrated, for example. In various embodiments, platform 802 and display 820 may be an integrated unit. Display 820 and content service device(s) 830 may be integrated, or display 820 and content delivery device(s) 840 may be integrated, for example. These examples are not meant to limit the present disclosure.

In various embodiments, system 800 may be implemented as a wireless system, a wired system, or a combination of both. When implemented as a wireless system, system 800 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 800 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 802 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 8.

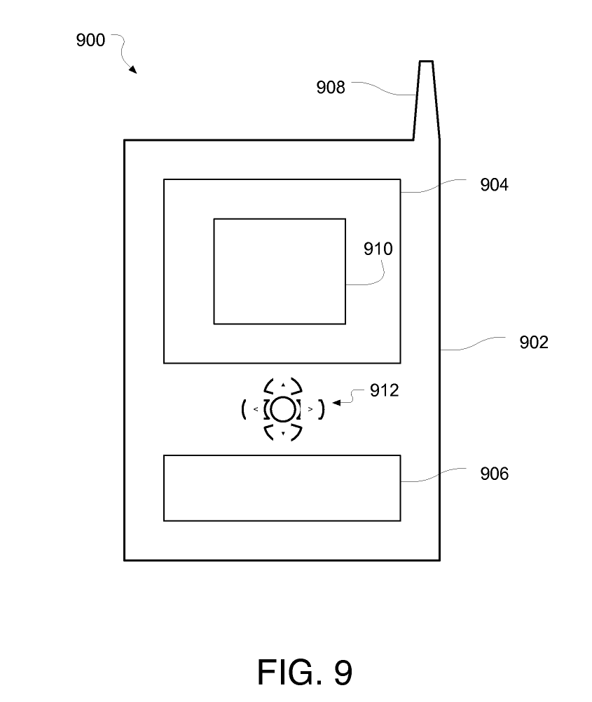

As described above, system 800 may be embodied in varying physical styles or form factors. FIG. 9 illustrates implementations of a small form factor device 900 in which system 800 may be embodied. In embodiments, for example, device 900 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 9, device 900 may include a housing 902, a display 904, an input/output (I/O) device 906, and an antenna 908. Device 900 also may include navigation features 912. Display 904 may include any suitable display unit for displaying information appropriate for a mobile computing device. I/O device 906 may include any suitable I/O device for entering information into a mobile computing device. Examples for I/O device 906 may include an alphanumeric keyboard, a numeric keypad, a touch pad, input keys, buttons, switches, rocker switches, microphones, speakers, voice recognition device and software, and so forth. Information also may be entered into device 900 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further embodiments.

In one example, a computer implemented method for motion estimation may include performing a hierarchical phase plane correlation on image data of a first video frame and image data of a second video frame to generate a plurality of candidate motion vectors. For an individual block of the image data of first video frame, a block matching may be performed based on the individual block and a first candidate block and a second candidate block of the image data of the second video frame to determine a matching block such that the first candidate block is associated with a first candidate motion vector of the candidate motion vectors and the second candidate block is associated with a second candidate motion vector of the candidate motion vectors. A motion vector for the individual block may be determined based on the individual block and the matching block.

In a further example of a computer implemented method for motion estimation, the hierarchical phase plane correlation may include two levels. The two levels may include a global level correlation and a local level correlation. Performing the global level correlation may include dividing both the image data of the first video frame and the image data of the second video frame into global regions, downscaling all of the global regions to a standard region size, and performing global phase plane correlations on the global regions of the image data of the first video frame and the corresponding global regions of the image data of the second video frame, wherein the global regions comprise four global regions. Performing the global phase plane correlations may include applying a windowing function to a first global region of the global regions of the image data of the first video frame and a corresponding global region of the image data of the second video frame, applying a discrete Fourier transform to the first global region and the corresponding global region, determining a cross power spectrum between the transformed first global region and the transformed corresponding global region, applying an inverse discrete Fourier transform to the cross power spectrum, performing a Fast Fourier Transform shift on the inverse transformed cross power spectrum to generate a correlation plane, and determining a correlation of peaks in the correlation plane to determine the first candidate motion vector. The discrete Fourier transform may be implemented using a radix-2 Fast Fourier Transform. The individual block may be within the first global region. Performing the local level correlation may include dividing both the image data of the first video frame and the image data of the second video frame into a plurality of local regions and performing local phase plane correlations on the plurality of local regions of the image data of the first video frame and the corresponding plurality of local regions of the image data of the second video frame. Performing the local phase plane correlations may include applying a windowing function to a first local region of the plurality regions of the image data of the first video frame and a corresponding local region of the plurality regions of the image data of the second video frame, applying a discrete Fourier transform to the first local region and the corresponding local region, determining a cross power spectrum between the transformed first local region and the transformed corresponding local region, applying an inverse discrete Fourier transform to the cross power spectrum to generate a correlation plane, and determining a correlation of peaks in the correlation plane to determine the second candidate motion vector. The discrete Fourier transform may be implemented using a radix-2 Fast Fourier Transform. The individual block may be within the first local region. Performing the block matching further may include performing the block matching based on a third candidate block of the image data of the second video frame such that the third candidate block may be associated with a third candidate motion vector determined based at least in part on the global phase plane correlations, a fourth candidate block of the image data of the second video frame such that the fourth candidate block may be associated with a fourth candidate motion vector determined based at least in part on the local phase plane correlations, a fifth candidate block of the image data of the second video frame such that the fifth candidate block may be associated with a fifth candidate motion vector determined based on a motion vector selected for the individual region in a previous motion estimation iteration, a sixth candidate block of the image data of the second video frame such that the sixth candidate block may be associated with a sixth candidate motion vector determined based on the motion vector selected for the individual region in the previous motion estimation iteration modified by a modification vector, wherein the modification vector is determined based on a heuristic algorithm, and a seventh candidate block of the image data of the second video frame such that the seventh candidate block is associated with a seventh candidate motion vector determined based on one or more motion vectors selected by blocks neighboring the individual block. The seventh candidate motion vector may be determined based on a median filter of three motion vectors selected by blocks neighboring the individual block. Performing the block matching may include evaluating a sum of absolute differences between the individual block and each of the candidate blocks. The image data of the first video frame may include luminance data of the first video frame and the image data of the second video frame may include luminance data of the second video frame. The first video frame and the second video frame may be consecutive frames in a video.

In another example, a system for video coding on a computer may include an antenna, one or more processors, one or more memory stores, a coder, a phase correlation module, and a block matching module. The antenna may be configured to transmit video data. The one or more memory stores communicatively may be coupled to the one or more processors. The coder may be communicatively coupled to the one or more processors and the antenna. The phase correlation module may be implemented via the coder and configured to perform a hierarchical phase plane correlation on image data of a first video frame and image data of a second video frame to generate a plurality of candidate motion vectors. The block matching module implemented via the coder and configured to perform, for an individual block of the image data of first video frame, a block matching based on the individual block and a first candidate block and a second candidate block of the image data of the second video frame to determine a matching block such that the first candidate block is associated with a first candidate motion vector of the candidate motion vectors and the second candidate block is associated with a second candidate motion vector of the candidate motion vectors and determine a motion vector for the individual block based on the individual block and the matching block. Transmitting video data may be based at least in part on the determined motion vector.

In a further example of a system for video coding on a computer, the hierarchical phase plane correlation may include two levels. The two levels may include a global level correlation and a local level correlation. Performing the global level correlation may include dividing both the image data of the first video frame and the image data of the second video frame into global regions, downscaling all of the global regions to a standard region size, and performing global phase plane correlations on the global regions of the image data of the first video frame and the corresponding global regions of the image data of the second video frame, wherein the global regions comprise four global regions. Performing the global phase plane correlations may include applying a windowing function to a first global region of the global regions of the image data of the first video frame and a corresponding global region of the image data of the second video frame, applying a discrete Fourier transform to the first global region and the corresponding global region, determining a cross power spectrum between the transformed first global region and the transformed corresponding global region, applying an inverse discrete Fourier transform to the cross power spectrum, performing a Fast Fourier Transform shift on the inverse transformed cross power spectrum to generate a correlation plane, and determining a correlation of peaks in the correlation plane to determine the first candidate motion vector. The discrete Fourier transform may be implemented using a radix-2 Fast Fourier Transform. The individual block may be within the first global region. Performing the local level correlation may include dividing both the image data of the first video frame and the image data of the second video frame into a plurality of local regions and performing local phase plane correlations on the plurality of local regions of the image data of the first video frame and the corresponding plurality of local regions of the image data of the second video frame. Performing the local phase plane correlations may include applying a windowing function to a first local region of the plurality regions of the image data of the first video frame and a corresponding local region of the plurality regions of the image data of the second video frame, applying a discrete Fourier transform to the first local region and the corresponding local region, determining a cross power spectrum between the transformed first local region and the transformed corresponding local region, applying an inverse discrete Fourier transform to the cross power spectrum to generate a correlation plane, and determining a correlation of peaks in the correlation plane to determine the second candidate motion vector. The discrete Fourier transform may be implemented using a radix-2 Fast Fourier Transform. The individual block may be within the first local region. The block matching module may be further configured to perform the block matching based on a third candidate block of the image data of the second video frame such that the third candidate block may be associated with a third candidate motion vector determined based at least in part on the global phase plane correlations, a fourth candidate block of the image data of the second video frame such that the fourth candidate block may be associated with a fourth candidate motion vector determined based at least in part on the local phase plane correlations, a fifth candidate block of the image data of the second video frame such that the fifth candidate block may be associated with a fifth candidate motion vector determined based on a motion vector selected for the individual region in a previous motion estimation iteration, a sixth candidate block of the image data of the second video frame such that the sixth candidate block may be associated with a sixth candidate motion vector determined based on the motion vector selected for the individual region in the previous motion estimation iteration modified by a modification vector, wherein the modification vector is determined based on a heuristic algorithm, and a seventh candidate block of the image data of the second video frame such that the seventh candidate block is associated with a seventh candidate motion vector determined based on one or more motion vectors selected by blocks neighboring the individual block. The seventh candidate motion vector may be determined based on a median filter of three motion vectors selected by blocks neighboring the individual block. The block matching module may be further configured to to perform the block matching by evaluating a sum of absolute differences between the individual block and the candidate blocks. The image data of the first video frame may include luminance data of the first video frame and the image data of the second video frame may include luminance data of the second video frame. The first video frame and the second video frame may be consecutive frames in a video.

In a further example, at least one machine readable medium may include a plurality of instructions that in response to being executed on a computing device, cause the computing device to perform the method according to any one of the above examples.

In a still further example, an apparatus may include means for performing the methods according to any one of the above examples.

The above examples may include specific combination of features. However, such the above examples are not limited in this regard and, in various implementations, the above examples may include the undertaking only a subset of such features, undertaking a different order of such features, undertaking a different combination of such features, and/or undertaking additional features than those features explicitly listed. For example, all features described with respect to the example methods may be implemented with respect to the example apparatus, the example systems, and/or the example articles, and vice versa.

What is claimed:

1. A computer-implemented method for motion estimation, comprising:
performing a hierarchical phase plane correlation on image data of a first video frame and image data of a second video frame to generate a plurality of candidate motion vectors;
performing, for an individual block of the image data of first video frame, a block matching based at least in part on the individual block and a first candidate block and a second candidate block of the image data of the second video frame to determine a matching block, wherein the first candidate block is associated with a first candidate motion vector of the candidate motion vectors and the second candidate block is associated with a second candidate motion vector of the candidate motion vectors; and
determining a motion vector for the individual block based at least in part on the individual block and the matching block.

2. The method of claim 1, wherein the hierarchical phase plane correlation comprises two levels.

3. The method of claim 1, wherein the hierarchical phase plane correlation comprises two levels, and wherein the two levels comprise a global level correlation and a local level correlation,
wherein performing the global level correlation comprises dividing both the image data of the first video frame and the image data of the second video frame into global regions, downscaling all of the global regions to a standard region size, and performing global phase plane correlations on the global regions of the image data of the first video frame and the corresponding global regions of the image data of the second video frame,
wherein performing the global phase plane correlations comprises applying a windowing function to a first global region of the global regions of the image data of the first video frame and a corresponding global region of the image data of the second video frame, applying a discrete Fourier transform to the first global region and the corresponding global region, determining a cross power spectrum between the transformed first global region and the transformed corresponding global region, applying an inverse discrete Fourier transform to the cross power spectrum, performing a Fast Fourier Transform shift on the inverse transformed cross power spectrum to generate a correlation plane, and determining a correlation of peaks in the correlation plane to determine the first candidate motion vector, and wherein the individual block is within the first global region.

4. The method of claim 1, wherein the hierarchical phase plane correlation comprises two levels, and wherein the two levels comprise a global level correlation and a local level correlation,
wherein performing the global level correlation comprises dividing both the image data of the first video frame and the image data of the second video frame into global regions, downscaling all of the global regions to a standard region size, and performing global phase plane correlations on the global regions of the image data of the first video frame and the corresponding global regions of the image data of the second video frame, wherein the global regions comprise four global regions,
wherein performing the global phase plane correlations comprises applying a windowing function to a first global region of the global regions of the image data of the first video frame and a corresponding global region of the image data of the second video frame, applying a discrete Fourier transform to the first global region and the corresponding global region, determining a cross power spectrum between the transformed first global region and the transformed corresponding global region, applying an inverse discrete Fourier transform to the cross power spectrum, performing a Fast Fourier Transform shift on the inverse transformed cross power spectrum to generate a correlation plane, and determining a correlation of peaks in the correlation plane to determine the first candidate motion vector, wherein the discrete Fourier transform is implemented using a radix-2 Fast Fourier Transform, and wherein the individual block is within the first global region.

5. The method of claim 1, wherein the hierarchical phase plane correlation comprises two levels, and wherein the two levels comprise a global level correlation and a local level correlation,
wherein performing the local level correlation comprises dividing both the image data of the first video frame and the image data of the second video frame into a plurality of local regions and performing local phase plane correlations on the plurality of local regions of the image data of the first video frame and the corresponding plurality of local regions of the image data of the second video frame,
wherein performing the local phase plane correlations comprises applying a windowing function to a first local region of the plurality regions of the image data of the first video frame and a corresponding local region of the plurality regions of the image data of the second video frame, applying a discrete Fourier transform to the first local region and the corresponding local region, determining a cross power spectrum between the transformed first local region and the transformed corresponding local region, applying an inverse discrete Fourier transform to the cross power spectrum to generate a correlation plane, and determining a correlation of peaks in the correlation plane to determine the second candidate motion vector, and wherein the individual block is within the first local region.

6. The method of claim 1, wherein the hierarchical phase plane correlation comprises two levels, and wherein the two levels comprise a global level correlation and a local level correlation,
wherein performing the local level correlation comprises dividing both the image data of the first video frame and the image data of the second video frame into a plurality of local regions and performing local phase plane correlations on the plurality of local regions of the image data of the first video frame and the corresponding plurality of local regions of the image data of the second video frame,
wherein performing the local phase plane correlations comprises applying a windowing function to a first local region of the plurality regions of the image data of the first video frame and a corresponding local region of the plurality regions of the image data of the second video frame, applying a discrete Fourier transform to the first local region and the corresponding local region, determining a cross power spectrum between the transformed first local region and the transformed corresponding local region, applying an inverse discrete Fourier transform to the cross power spectrum to generate a correlation plane, and determining a correlation of peaks in the correlation plane to determine the second candidate motion vector, wherein the discrete Fourier transform is implemented using a radix-2 Fast Fourier Transform, and wherein the individual block is within the first local region.

7. The method of claim 1, wherein performing the block matching further comprises performing the block matching based at least in part on:
a third candidate block of the image data of the second video frame wherein the third candidate block is associated with a third candidate motion vector determined based at least in part on a motion vector selected for the individual region in a previous motion estimation iteration,
a fourth candidate block of the image data of the second video frame wherein the fourth candidate block is associated with a fourth candidate motion vector determined based at least in part on the motion vector selected for the individual region in the previous motion estimation iteration modified by a modification vector, wherein the modification vector is determined based at least in part on a heuristic algorithm, and
a fifth candidate block of the image data of the second video frame wherein the fifth candidate block is associated with a fifth candidate motion vector determined based at least in part on one or more motion vectors selected by blocks neighboring the individual block, and wherein the fifth candidate motion vector is determined based at least in part on a median filter of three motion vectors selected by blocks neighboring the individual block.

8. The method of claim 1, wherein the hierarchical phase plane correlation comprises two levels, and wherein the two levels comprise a global level correlation and a local level correlation,
wherein performing the global level correlation comprises dividing both the image data of the first video frame and the image data of the second video frame into global regions, downscaling all of the global regions to a standard region size, and performing global phase plane correlations on the global regions of the image data of the first video frame and the corresponding global regions of the image data of the second video frame,
wherein performing the global phase plane correlations comprises determining the first candidate motion vector based at least in part on a first global region of the global regions of the image data of the first video frame and a corresponding global region of the image data of the second video frame,
wherein performing the local level correlation comprises dividing both the image data of the first video frame and the image data of the second video frame into a plurality of local regions and performing local phase plane correlations on the plurality of local regions of the image data of the first video frame and the corresponding plurality of local regions of the image data of the second video frame,
wherein performing the local phase plane correlations comprises determining the second candidate motion vector based at least in part on a a first local region of the plurality regions of the image data of the first video frame and a corresponding local region of the plurality regions of the image data of the second video frame, and
wherein performing the block matching further comprises performing the block matching based at least in part on:
a third candidate block of the image data of the second video frame wherein the third candidate block is associated with a third candidate motion vector determined based at least in part on the global phase plane correlations,
a fourth candidate block of the image data of the second video frame wherein the fourth candidate block is associated with a fourth candidate motion vector determined based at least in part on the local phase plane correlations,
a fifth candidate block of the image data of the second video frame wherein the fifth candidate block is associated with a fifth candidate motion vector determined based at least in part on a motion vector selected for the individual region in a previous motion estimation iteration,
a sixth candidate block of the image data of the second video frame wherein the sixth candidate block is associated with a sixth candidate motion vector determined based at least in part on the motion vector selected for the individual region in the previous motion estimation iteration modified by a modification vector, wherein the modification vector is determined based at least in part on a heuristic algorithm, and
a seventh candidate block of the image data of the second video frame wherein the seventh candidate block is associated with a seventh candidate motion vector determined based at least in part on one or more motion vectors selected by blocks neighboring the individual block, and wherein the seventh candidate motion vector is determined based at least in part on a median filter of three motion vectors selected by blocks neighboring the individual block.

9. The method of claim 1, wherein performing the block matching comprises evaluating a sum of absolute differences between the individual block and each of the candidate blocks.

10. The method of claim 1, wherein the image data of the first video frame comprises luminance data of the first video frame and the image data of the second video frame comprises luminance data of the second video frame.

11. The method of claim 1, wherein the hierarchical phase plane correlation comprises two levels, and wherein the two levels comprise a global level correlation and a local level correlation,
wherein performing the global level correlation comprises dividing both the image data of the first video frame and the image data of the second video frame into global regions, downscaling all of the global regions to a standard region size, and performing global phase plane correlations on the global regions of the image data of the first video frame and the corresponding global regions of the image data of the second video frame, wherein the global regions comprise four global regions,
wherein performing the global phase plane correlations comprises applying a windowing function to a first global region of the global regions of the image data of the first video frame and a corresponding global region of the image data of the second video frame, applying a discrete Fourier transform to the first global region and the corresponding global region, determining a cross power spectrum between the transformed first global region and the transformed corresponding global region, applying an inverse discrete Fourier transform to the cross power spectrum, performing a Fast Fourier Transform shift on the inverse transformed cross power spectrum to generate a correlation plane, and determining a correlation of peaks in the correlation plane to determine the first candidate motion vector, wherein the discrete Fourier transform is implemented using a radix-2 Fast Fourier Transform, and wherein the individual block is within the first global region,
wherein performing the local level correlation comprises dividing both the image data of the first video frame and the image data of the second video frame into a plurality of local regions and performing local phase plane correlations on the plurality of local regions of the image data of the first video frame and the corresponding plurality of local regions of the image data of the second video frame,
wherein performing the local phase plane correlations comprises applying a windowing function to a first local region of the plurality regions of the image data of the first video frame and a corresponding local region of the plurality regions of the image data of the second video frame, applying a discrete Fourier transform to the first local region and the corresponding local region, determining a cross power spectrum between the transformed first local region and the transformed corresponding local region, applying an inverse discrete Fourier transform to the cross power spectrum to generate a correlation plane, and determining a correlation of peaks in the correlation plane to determine the second candidate motion vector, wherein the discrete Fourier transform is implemented using a radix-2 Fast Fourier Transform, and wherein the individual block is within the first local region,
wherein performing the block matching further comprises performing the block matching based at least in part on:
a third candidate block of the image data of the second video frame wherein the third candidate block is associated with a third candidate motion vector determined based at least in part on the global phase plane correlations,
a fourth candidate block of the image data of the second video frame wherein the fourth candidate block is associated with a fourth candidate motion vector determined based at least in part on the local phase plane correlations,
a fifth candidate block of the image data of the second video frame wherein the fifth candidate block is associated with a fifth candidate motion vector determined based at least in part on a motion vector selected for the individual region in a previous motion estimation iteration,
a sixth candidate block of the image data of the second video frame wherein the sixth candidate block is associated with a sixth candidate motion vector determined based at least in part on the motion vector selected for the individual region in the previous motion estimation iteration modified by a modification vector, wherein the modification vector is determined based at least in part on a heuristic algorithm, and
a seventh candidate block of the image data of the second video frame wherein the seventh candidate block is associated with a seventh candidate motion vector determined based at least in part on one or more motion vectors selected by blocks neighboring the individual block, and wherein the seventh candidate motion vector is determined based at least in part on a median filter of three motion vectors selected by blocks neighboring the individual block,
wherein performing the block matching comprises evaluating a sum of absolute differences between the individual block and each of the candidate blocks,
wherein the image data of the first video frame comprises luminance data of the first video frame and the image data of the second video frame comprises luminance data of the second video frame, and
wherein the first video frame and the second video frame comprise consecutive frames in a video.

12. A system for video coding on a computer, comprising:
an antenna for transmitting video data;
one or more processors;
one or more memory stores communicatively coupled to the one or more processors;
a coder communicatively coupled to the one or more processors and the antenna;
a phase correlation module implemented via the coder and configured to perform a hierarchical phase plane correlation on image data of a first video frame and image data of a second video frame to generate a plurality of candidate motion vectors; and
a block matching module implemented via the coder and configured to:
perform, for an individual block of the image data of first video frame, a block matching based at least in part on the individual block and a first candidate block and a second candidate block of the image data of the second video frame to determine a matching block, wherein the first candidate block is associated with a first candidate motion vector of the candidate motion vectors and the second candidate block is associated with a second candidate motion vector of the candidate motion vectors; and
determine a motion vector for the individual block based at least in part on the individual block and the matching block,
wherein transmitting the video data is based at least in part on the determined motion vector.

13. The system of claim 12, wherein the hierarchical phase plane correlation comprises two levels.

14. The system of claim 12, wherein the hierarchical phase plane correlation comprises two levels, and wherein the two levels comprise a global level correlation and a local level correlation,
wherein the phase correlation module is configured to perform the global level correlation by dividing both the image data of the first video frame and the image data of the second video frame into global regions, downscaling all of the global regions to a standard region size, and performing global phase plane correlations on the global regions of the image data of the first video frame and the corresponding global regions of the image data of the second video frame,
wherein performing the global phase plane correlations comprises applying a windowing function to a first global region of the global regions of the image data of the first video frame and a corresponding global region of the image data of the second video frame, applying a discrete Fourier transform to the first global region and the corresponding global region, determining a cross power spectrum between the transformed first global region and the transformed corresponding global region, applying an inverse discrete Fourier transform to the cross power spectrum, performing a Fast Fourier Transform shift on the inverse transformed cross power spectrum to generate a correlation plane, and determining a correlation of peaks in the correlation plane to determine the first candidate motion vector, and wherein the individual block is within the first global region.

15. The system of claim 12, wherein the hierarchical phase plane correlation comprises two levels, and wherein the two levels comprise a global level correlation and a local level correlation,
wherein the phase correlation module is configured to perform the local level correlation by dividing both the image data of the first video frame and the image data of the second video frame into a plurality of local regions and performing local phase plane correlations on the plurality of local regions of the image data of the first video frame and the corresponding plurality of local regions of the image data of the second video frame,
wherein performing the local phase plane correlations comprises applying a windowing function to a first local region of the plurality regions of the image data of the first video frame and a corresponding local region of the plurality regions of the image data of the second video frame, applying a discrete Fourier transform to the first local region and the corresponding local region, determining a cross power spectrum between the transformed first local region and the transformed corresponding local region, applying an inverse discrete Fourier transform to the cross power spectrum to generate a correlation plane, and determining a correlation of peaks in the correlation plane to determine the second candidate motion vector, and wherein the individual block is within the first local region.

16. The system of claim 12, wherein the block matching module is further configured to perform the block matching based at least in part on:
a third candidate block of the image data of the second video frame wherein the third candidate block is associated with a third candidate motion vector determined based at least in part on a motion vector selected for the individual region in a previous motion estimation iteration,
a fourth candidate block of the image data of the second video frame wherein the fourth candidate block is associated with a fourth candidate motion vector determined based at least in part on the motion vector selected for the individual region in the previous motion estimation iteration modified by a modification vector, wherein the modification vector is determined based at least in part on a heuristic algorithm, and
a fifth candidate block of the image data of the second video frame wherein the fifth candidate block is associated with a fifth candidate motion vector determined based at least in part on one or more motion vectors selected by blocks neighboring the individual block, and wherein the fifth candidate motion vector is determined based at least in part on a median filter of three motion vectors selected by blocks neighboring the individual block.

17. The system of claim 12, wherein the hierarchical phase plane correlation comprises two levels, and wherein the two levels comprise a global level correlation and a local level correlation,
wherein the phase plane correlation module is configured to perform the global level correlation by dividing both the image data of the first video frame and the image data of the second video frame into global regions, downscaling all of the global regions to a standard region size, and performing global phase plane correlations on the global regions of the image data of the first video frame and the corresponding global regions of the image data of the second video frame,
wherein performing the global phase plane correlations comprises determining the first candidate motion vector based at least in part on a first global region of the global regions of the image data of the first video frame and a corresponding global region of the image data of the second video frame,
wherein the phase plane correlation module is configured to perform the local level correlation by dividing both the image data of the first video frame and the image data of the second video frame into a plurality of local regions and performing local phase plane correlations on the plurality of local regions of the image data of the first video frame and the corresponding plurality of local regions of the image data of the second video frame,
wherein performing the local phase plane correlations comprises determining the second candidate motion vector based at least in part on a a first local region of the plurality regions of the image data of the first video frame and a corresponding local region of the plurality regions of the image data of the second video frame, and
wherein the block matching module is further configured to perform the block matching based at least in part on:
a third candidate block of the image data of the second video frame wherein the third candidate block is associated with a third candidate motion vector determined based at least in part on the global phase plane correlations,
a fourth candidate block of the image data of the second video frame wherein the fourth candidate block is associated with a fourth candidate motion vector determined based at least in part on the local phase plane correlations,
a fifth candidate block of the image data of the second video frame wherein the fifth candidate block is associated with a fifth candidate motion vector determined based at least in part on a motion vector selected for the individual region in a previous motion estimation iteration,
a sixth candidate block of the image data of the second video frame wherein the sixth candidate block is associated with a sixth candidate motion vector determined based at least in part on the motion vector selected for the individual region in the previous motion estimation iteration modified by a modification vector, wherein the modification vector is determined based at least in part on a heuristic algorithm, and
a seventh candidate block of the image data of the second video frame wherein the seventh candidate block is associated with a seventh candidate motion vector determined based at least in part on one or more motion vectors selected by blocks neighboring the individual block, and wherein the seventh candidate motion vector is determined based at least in part on a median filter of three motion vectors selected by blocks neighboring the individual block.

18. The system of claim 12, wherein the block matching module is configured to perform the block matching by evaluating a sum of absolute differences between the individual block and each of the candidate blocks.

19. The system of claim 12, wherein the image data of the first video frame comprises luminance data of the first video frame and the image data of the second video frame comprises luminance data of the second video frame.

20. The system of claim 12, wherein the hierarchical phase plane correlation comprises two levels, and wherein the two levels comprise a global level correlation and a local level correlation,
wherein performing the global level correlation comprises dividing both the image data of the first video frame and the image data of the second video frame into global regions, downscaling all of the global regions to a standard region size, and performing global phase plane correlations on the global regions of the image data of the first video frame and the corresponding global regions of the image data of the second video frame, wherein the global regions comprise four global regions,
wherein performing the global phase plane correlations comprises applying a windowing function to a first global region of the global regions of the image data of the first video frame and a corresponding global region of the image data of the second video frame, applying a discrete Fourier transform to the first global region and the corresponding global region, determining a cross power spectrum between the transformed first global region and the transformed corresponding global region, applying an inverse discrete Fourier transform to the cross power spectrum, performing a Fast Fourier Transform shift on the inverse transformed cross power spectrum to generate a correlation plane, and determining a correlation of peaks in the correlation plane to determine the first candidate motion vector, wherein the discrete Fourier transform is implemented using a radix-2 Fast Fourier Transform, and wherein the individual block is within the first global region,
wherein performing the local level correlation comprises dividing both the image data of the first video frame and the image data of the second video frame into a plurality of local regions and performing local phase plane correlations on the plurality of local regions of the image data of the first video frame and the corresponding plurality of local regions of the image data of the second video frame,
wherein performing the local phase plane correlations comprises applying a windowing function to a first local region of the plurality regions of the image data of the first video frame and a corresponding local region of the plurality regions of the image data of the second video frame, applying a discrete Fourier transform to the first local region and the corresponding local region, determining a cross power spectrum between the transformed first local region and the transformed corresponding local region, applying an inverse discrete Fourier transform to the cross power spectrum to generate a correlation plane, and determining a correlation of peaks in the correlation plane to determine the second candidate motion vector, wherein the discrete Fourier transform is implemented using a radix-2 Fast Fourier Transform, and wherein the individual block is within the first local region,
wherein the block matching module is further configured to perform the block matching based at least in part on:
a third candidate block of the image data of the second video frame wherein the third candidate block is associated with a third candidate motion vector determined based at least in part on the global phase plane correlations,
a fourth candidate block of the image data of the second video frame wherein the fourth candidate block is associated with a fourth candidate motion vector determined based at least in part on the local phase plane correlations,
a fifth candidate block of the image data of the second video frame wherein the fifth candidate block is associated with a fifth candidate motion vector determined based at least in part on a motion vector selected for the individual region in a previous motion estimation iteration,
a sixth candidate block of the image data of the second video frame wherein the sixth candidate block is associated with a sixth candidate motion vector determined based at least in part on the motion vector selected for the individual region in the previous motion estimation iteration modified by a modification vector, wherein the modification vector is determined based at least in part on a heuristic algorithm, and
a seventh candidate block of the image data of the second video frame wherein the seventh candidate block is associated with a seventh candidate motion vector determined based at least in part on one or more motion vectors selected by blocks neighboring the individual block, and wherein the seventh candidate motion vector is determined based at least in part on a median filter of three motion vectors selected by blocks neighboring the individual block,
wherein the block matching module is configured to perform the block matching by evaluating a sum of absolute differences between the individual block and the candidate blocks,
wherein the image data of the first video frame comprises luminance data of the first video frame and the image data of the second video frame comprises luminance data of the second video frame, and
wherein the first video frame and the second video frame comprise consecutive frames in a video.

22. At least one machine readable medium comprising a plurality of instructions that in response to being executed on a computing device, cause the computing device to provide motion estimation by:
performing a hierarchical phase plane correlation on image data of a first video frame and image data of a second video frame to generate a plurality of candidate motion vectors;
performing, for an individual block of the image data of first video frame, a block matching based at least in part on the individual block and a first candidate block and a second candidate block of the image data of the second video frame to determine a matching block, wherein the first candidate block is associated with a first candidate motion vector of the candidate motion vectors and the second candidate block is associated with a second candidate motion vector of the candidate motion vectors; and
determining a motion vector for the individual block based at least in part on the individual block and the matching block.

23. The machine readable medium of claim 22, wherein the hierarchical phase plane correlation comprises two levels, and wherein the two levels comprise a global level correlation and a local level correlation,
wherein performing the global level correlation comprises dividing both the image data of the first video frame and the image data of the second video frame into global regions, downscaling all of the global regions to a standard region size, and performing global phase plane correlations on the global regions of the image data of the first video frame and the corresponding global regions of the image data of the second video frame,
wherein performing the global phase plane correlations comprises applying a windowing function to a first global region of the global regions of the image data of the first video frame and a corresponding global region of the image data of the second video frame, applying a discrete Fourier transform to the first global region and the corresponding global region, determining a cross power spectrum between the transformed first global region and the transformed corresponding global region, applying an inverse discrete Fourier transform to the cross power spectrum, performing a Fast Fourier Transform shift on the inverse transformed cross power spectrum to generate a correlation plane, and determining a correlation of peaks in the correlation plane to determine the first candidate motion vector, and wherein the individual block is within the first global region.

24. The machine readable medium of claim 22, wherein performing the block matching comprises evaluating a sum of absolute differences between the individual block and each of the candidate blocks.

25. The machine readable medium of claim 22, wherein the hierarchical phase plane correlation comprises two levels, and wherein the two levels comprise a global level correlation and a local level correlation,
wherein performing the global level correlation comprises dividing both the image data of the first video frame and the image data of the second video frame into global regions, downscaling all of the global regions to a standard region size, and performing global phase plane correlations on the global regions of the image data of the first video frame and the corresponding global regions of the image data of the second video frame, wherein the global regions comprise four global regions,
wherein performing the global phase plane correlations comprises applying a windowing function to a first global region of the global regions of the image data of the first video frame and a corresponding global region of the image data of the second video frame, applying a discrete Fourier transform to the first global region and the corresponding global region, determining a cross power spectrum between the transformed first global region and the transformed corresponding global region, applying an inverse discrete Fourier transform to the cross power spectrum, performing a Fast Fourier Transform shift on the inverse transformed cross power spectrum to generate a correlation plane, and determining a correlation of peaks in the correlation plane to determine the first candidate motion vector, wherein the discrete Fourier transform is implemented using a radix-2 Fast Fourier Transform, and wherein the individual block is within the first global region,
wherein performing the local level correlation comprises dividing both the image data of the first video frame and the image data of the second video frame into a plurality of local regions and performing local phase plane correlations on the plurality of local regions of the image data of the first video frame and the corresponding plurality of local regions of the image data of the second video frame,
wherein performing the local phase plane correlations comprises applying a windowing function to a first local region of the plurality regions of the image data of the first video frame and a corresponding local region of the plurality regions of the image data of the second video frame, applying a discrete Fourier transform to the first local region and the corresponding local region, determining a cross power spectrum between the transformed first local region and the transformed corresponding local region, applying an inverse discrete Fourier transform to the cross power spectrum to generate a correlation plane, and determining a correlation of peaks in the correlation plane to determine the second candidate motion vector, wherein the discrete Fourier transform is implemented using a radix-2 Fast Fourier Transform, and wherein the individual block is within the first local region,
wherein performing the block matching further comprises performing the block matching based at least in part on:
a third candidate block of the image data of the second video frame wherein the third candidate block is associated with a third candidate motion vector determined based at least in part on the global phase plane correlations,
a fourth candidate block of the image data of the second video frame wherein the fourth candidate block is associated with a fourth candidate motion vector determined based at least in part on the local phase plane correlations,
a fifth candidate block of the image data of the second video frame wherein the fifth candidate block is associated with a fifth candidate motion vector determined based at least in part on a motion vector selected for the individual region in a previous motion estimation iteration,
a sixth candidate block of the image data of the second video frame wherein the sixth candidate block is associated with a sixth candidate motion vector determined based at least in part on the motion vector selected for the individual region in the previous motion estimation iteration modified by a modification vector, wherein the modification vector is determined based at least in part on a heuristic algorithm, and
a seventh candidate block of the image data of the second video frame wherein the seventh candidate block is associated with a seventh candidate motion vector determined based at least in part on one or more motion vectors selected by blocks neighboring the individual block, and wherein the seventh candidate motion vector is determined based at least in part on a median filter of three motion vectors selected by blocks neighboring the individual block,
wherein performing the block matching comprises evaluating a sum of absolute differences between the individual block and each of the candidate blocks,
wherein the image data of the first video frame comprises luminance data of the first video frame and the image data of the second video frame comprises luminance data of the second video frame, and
wherein the first video frame and the second video frame comprise consecutive frames in a video.
